(19) United States
(12) Patent Application Publication
(10) Pub. No.: US 2016/0183328 A1
(43) Pub. Date: Jun. 23, 2016

(54) METHOD AND DEVICES FOR HIGH TEMPERATURE THICK FILM PASTES

(71) Applicant: E I DU PONT DE NEMOURS AND COMPANY, Wilmington, DE (US)

(72) Inventors: JOHN GRAEME PEPIN, RALEIGH, NC (US); JOHN DONALD SUMMERS, CHAPEL HILL, NC (US); SEIGI SUH, CARY, NC (US); KURT DOUGLAS ROBERTS, RALEIGH, NC (US); DANNY E GLENN, CIRCLEVILLE, OH (US)

(21) Appl. No.: 14/972,840

(22) Filed: Dec. 17, 2015

Related U.S. Application Data
(60) Provisional application No. 62/093,021, filed on Dec. 17, 2014.

(51) Int. Cl. H05B 3/03; H05B 3/10; H05B 3/34; H01C 17/28

(52) U.S. Cl. CPC H05B 3/03; H01C 17/283; H05B 3/10; H05B 3/34

(57) ABSTRACT

The present invention relates to the design, construction and manufacture of a novel electrical high temperature heater having a polymer thick film conductor paste with which to form an electrode on resistive film.

### BACKGROUND INFORMATION

1. Field of the Disclosure

The present invention relates to the design, construction and manufacture of a novel high temperature heater utilizing a resistive film and a high temperature polymer thick film conductor paste.

2. Description of the Related Art

Silver (Ag)-based thick film pastes for application to polymeric substrates are well-known in the state of the art. Such pastes are typically dispersions of Ag flakes and/or spherical Ag powders in organic vehicles comprising polymeric resins dissolved in various solvents. These pastes are typically 40 to 85 weight percent Ag, with the paste viscosities being typically 5 to 250 Pas at shear rates of 0.4/sec at room temperature. The solvents used in such pastes are those best suited to screen printing in that they are non-toxic, do not have an offensive smell, dry in appropriate times and temperatures, have adequate working time on printing screens, and dissolve the given polymeric resins completely to make a solution which has proper viscosity for screen printing when mixed with the powders in various ratios with those powders dispersed into the solution. A primary issue, however, with such technology is that the polymeric resins contained in common Ag thick film pastes are not capable of sustained high temperature operation. The polymers included in such pastes are, for example, phenoxy, polyolefins, polyurethanes, and acrylics and the like, with glass transition temperatures and thermal degradation limits which preclude effective use at continuously high temperatures. Such polymers would decompose and render the thick film prints useless at those elevated and continuous temperatures. As such, using these types of compositions are not possible as electrical bus bars for polymeric heating films such as like Kapton® 200RS100 without eventual degradation and possible safety and long term performance consequences.

Polymers based on polyimide chemistries offer the possibility of continuous high temperature operation if they can be used in an equivalent polymer thick film paste. A particular issue with current commercially available polyimide resins is that they are typically supplied as only dissolved in solvents such as DMAC and/or NMP, or as dried polymer powders which are only soluble in such solvents. Solvents such as DMAC and NMP and the like are not amenable to use as solvents in screen printing pastes due to their smell, toxicity, poorly-matched drying rates and reactivity with equipment and printing screens. And such commercially available solutions of polyimides in DMAC and/or NMP are typically dilute with respect to the polyimide content resulting in organic solutions that are too low in viscosity and too low in resin content for use as the basis for a thick film paste. As such, commercially available polyimide solutions and polyimide powders are not amenable to use as the basis for formulating and manufacturing a thick film paste.

Needed in the art is a replacement for the standard polymeric composition of routine and well-known electrically Ag conductive thick film pastes which make printed and dried paste survivable at continuously elevated temperatures and is an enabling technology for using, e.g. the like Kapton® 200RS100, film as an electrically resistive high temperature heater in temperature ranges attractive for devices which require temperatures of approximately 200° C.

### SUMMARY

The present invention is directed to a polymeric composition of electrically Ag conductive thick film pastes with a polyimide type of polymer which makes the printed and dried paste survivable at continuously elevated temperatures and is an enabling technology for using, e.g. the like Kapton® 200RS100, film as an electrically resistive high temperature heater in temperature ranges attractive for devices which require temperatures of a maximum of approximately 100 to 210° C.

In a first embodiment, the present invention is directed to a method to prepare a high temperature heater construct including an electrically conductive polyimide film to which bus bars made of electrically conductive polymer thick film paste containing a dispersion of Ag particles in a thick film paste are applied. The technology is enabling in using the conductive polyimide film in that the Ag polyimide-based paste allows the printing and construction of an electrical contact with the polyimide film such that the polyimide film can then be used as an electrode. For example, like Kapton® 200RS100 film is an electrically resistive high temperature heater in temperature ranges attractive for devices which require temperatures of approximately 25° C. to 210° C. However adequate thick film paste compositions enabling its use as an electrode do not exist.

In another embodiment, the invention is directed to a process for the preparation of a high temperature heater wherein the electrode is made of the thick film paste deposition on the electrically resistive polyimide film is folded or curved to be placed into a device for heating a substance such as food or water.

### BRIEF DESCRIPTION OF THE DRAWINGS

FIG. 1 and FIG. 2 are schematic of a typical high temperature heater made using like Kapton® 200RS100 film and electrically conductive polymer thick film paste electrodes which have been printed on the film to render an electrically driven high temperature heater capable of long term heating in the range of 100 to 210° C. in air; and

FIG. 1A is a thermal image of the elements heated using 220 V and heated to 207° C.

FIGS. 2A and 2B are photographs of the high temperature heater of FIG. 2 is a thermal image of the elements heated by using 12 VDC and 24 VDC resulting in heater temperature outputs of 78.5° C. and 202° C.

FIG. 3 shows 200RS100 with 26 cm bus bar spacing on metal container.

FIG. 4 shows 200RS100 with 26 cm bar spacing on metal container.

FIG. 5 shows 200RS100 with 26 cm bar spacing on metal container (220 VAC)—with fiber glass wall wrap.

### DETAILED DESCRIPTION

In a first embodiment, the invention is directed to a method to prepare a high temperature heater including preparing an electrically high temperature conductive paste; printing and drying the paste on an electrically resistive polyimide film and attaching a power source to the electrically conductive high temperature paste electrodes. The electrically high temperature conductive paste includes a polyimide polymer represented by formula I:

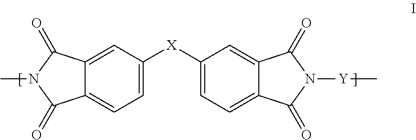

wherein X is C(CH3)2, O, S(O)2 or C(CF3)2, O-Ph-C(CH₃)₂-Ph-O, O-Ph-O— or a mixture of two, or more of C(CH3)2, O, S(O)2, and C(CF3)2, O-Ph-C(CH₃)₂-Ph-O, O-Ph-O—;
wherein Y is diamine component or mixture of diamine components selected from the group consisting of:
m-phenylenediamine (MPD), 3,4′-diaminodiphenyl ether (3,4′-ODA), 4,4′-diamino-2,2′-bis(trifluoromethyl)biphenyl (TFMB), 3,3′-diaminodiphenyl sulfone (3,3′-DDS), 4,4′-(Hexafluoroisopropylidene)bis(2-aminophenol) (6F-AP) bis-(4-(4-aminophenoxy)phenyl)sulfone (BAPS) and 9,9-bis(4-aminophenyl)fluorene (FDA); 2,3,5,6-tetramethyl-1,4-phenylenediamine (DAM), 2,2-bis[4-(4-aminophenoxyphenyl)]propane (BAPP), 2,2-bis[4-(4-aminophenoxyphenyl)] hexafluoropropane (HFBAPP), 1,3-bis(3-aminophenoxy) benzene (APB-133), 2,2-bis(3-aminophenyl)hexafluoropropane, 2,2-bis(4 aminophenyl)hexafluoropropane (Bis-A-AF), 4,4′-bis(4-amino-2-trifluoromethylphenoxy) biphenyl, 4,4′-[1,3-phenylenebis(1-methyl-ethylidene)]bisaniline (Bisaniline-M) with the proviso that:
i. if X is O, then Y is not m-phenylenediamine (MPD), bis-(4-(4-aminophenoxy)phenyl)sulfone (BAPS) and 3,4′-diaminodiphenyl ether (3,4′-ODA); BAPP, APB-133, Bisaniline-M;
ii. if X is S(O)₂, then Y is not 3,3′-diaminodiphenyl sulfone (3,3′-DDS);
iii. if X is C(CF₃)₂, then Y is not m-phenylenediamine (MPD), bis-(4-(4-aminophenoxy)phenyl)sulfone (BAPS), 9,9-bis(4-aminophenyl)fluorene (FDA), and 3,3′-diaminodiphenyl sulfone (3,3′-DDS);
iv. if X is O-Ph-C(CH₃)₂-Ph-O or O-Ph-O—, then Y is not m-phenylene diamine (MPD), FDA, 3,4′-ODA, DAM, BAPP, APB-133, bisaniline-M.

This paste is advantageous in that it contains solvents which are not based on the typical DMAC or NMP solvents normally used with polyimides, but based on solvents which are more amenable to screen printing, having less toxicity and better handling, viscosity and drying processing windows for routine screen printing. Because this conductive paste is based on polyimide chemistry, it is also thermally stable after printing and drying and enables an electrical connection to the polymeric resistive film such that a high temperature electrode and subsequent heater can be made.

More particularly, the present embodiment relates to the formulation and application of a Ag or other conductive metal powder in an organic solution of a solvent soluble polyimide to form a thick film paste, those solvents being amenable to screen printing, including such solvents as Dowanol DPM, Dowanol PMA, di-basic esters, lactamides, acetates, diethyl adipate, texanol, glycol ethers, carbitols, and the like. Such solvents can dissolve the solvent-soluble polyimide resin and render a solution to which Ag and other electrically conductive metal powders can be dispersed, rendering a screen-printable thick film paste composition. Solution of the polyimide resin in the selected solvents is possible through the selection of the monomers used to make the polyimide. Metals other than Ag, such as Ni, Cu, Pt, Pd and the like, and powders of various morphologies and combinations of those morphologies are possible for use in the present invention.

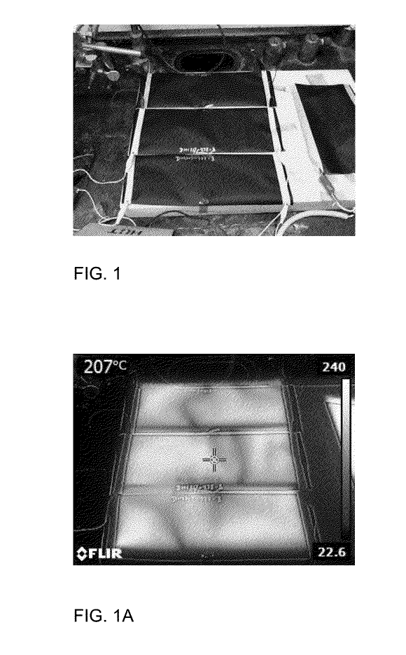

Referring to FIG. 1, the paste of the present invention is printed to a thickness of 10 to 15 microns wet, then dried at 130 C in air for 10 minutes then dried again at 200 C for 10 minutes. The size and placement of the bus bars of the Ag paste was determined by recognizing the electrical resistance of the like Kapton® 200RS100 film at the operating temperature of approximately 200 C, and the desired voltage to be supplied, being 220 V in this example. Such a high temperature heater 10 construct has been shown to survive continuous operation at approximately 200 C for up to 700 hours, with thermal cycling on and off during that testing period.

Referring to FIG. 1 and FIG. 1A, in another embodiment, the invention is directed to a high temperature heater 10 including a polyimide-based polymeric resistive film 12 of the previous embodiment with electrically conductive fillers dispersed therein such that the film has electrical conductivity. The films of the present invention are typically capable of continuous operation at a maximum of approximately 210° C., with shorter term peaks of 225 to 240° C. possible without damage; an example of such film is like Kapton® 200RS100. Again referring to FIG. 1A, a thermal image of the high temperature heater 10 is illustrated while heated, using 220 V and heated to 207° C. with a polymeric composition of electrically conductive thick film paste with a polyimide type of polymer which makes the printed and dried paste survivable at the continuously elevated temperatures.

To enable electrical connection to the film, the thick film paste having a dispersion of silver particles in a polyimide resin vehicle is used provide electrical connection through the formation of spaced bus bars via screen printing. This paste comprising the bus bars can be connected to power sources using electrical clamps or clips commonly known in the industry.

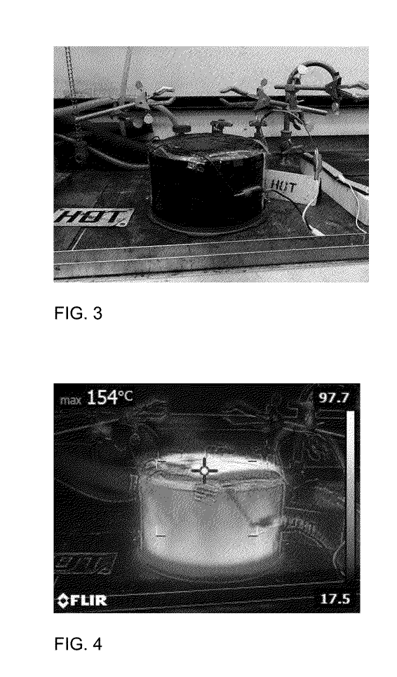

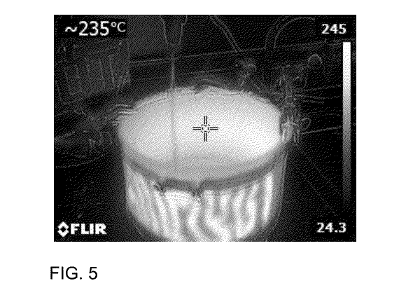

Preferably the paste includes an inorganic filler of Ag in the amount of 40 to 80% by weight and has a thickness of 5 to 40 microns dried, thereby have an electrical resistivity of about 4 to 70 mohms/sq/mil. Such a high temperature heater could be, for example, wrapped around a thermally conducting (non-electrical conducting) container for supply of heat to a device for heating food or water (refer to FIGS. 3, 4, and 5). If the container to be heated is electrically conductive, then a dielectric barrier is needed between the Kapton® 200RS100 with printed paste and the container to be heated (refer to FIGS. 3, 4, and 5). Examples of dielectric barriers potentially to be used can consist of but not limited to Teflon® FEP, Teflon®PFA, Pyralux® LF, Pyralux® LG, fiber glass weaves, etc. (refer to FIGS. 3, 4, and 5).

In another embodiment, the invention is directed to a device for maintaining the temperature of materials. The device would include a base portion having a chamber section with a high temperature heater contacting the chamber section. In addition, the device would include a power source for the high temperature heater and a lid for the chamber section. The electrically conductive high temperature paste comprises a polyimide resin as represented by formula I:

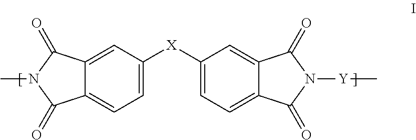

wherein X is C(CH3)2, O, S(O)2 or C(CF3)2, O-Ph-C(CH₃)₂-Ph-O, O-Ph-O— or a mixture of two, or more of C(CH3)2, O, S(O)2, and C(CF3)2, O-Ph-C(CH₃)₂-Ph-O, O-Ph-O—; wherein Y is diamine component or mixture of diamine components selected from the group consisting of:
m-phenylenediamine (MPD), 3,4′-diaminodiphenyl ether (3,4′-ODA), 4,4′-diamino-2,2′-bis(trifluoromethyl)biphenyl (TFMB), 3,3′-diaminodiphenyl sulfone (3,3′-DDS), 4,4′-(Hexafluoroisopropylidene)bis(2-aminophenol) (6F-AP) bis-(4-(4-aminophenoxy)phenyl)sulfone (BAPS) and 9,9-bis(4-aminophenyl)fluorene (FDA); 2,3,5,6-tetramethyl-1,4-phenylenediamine (DAM), 2,2-bis[4-(4-aminophenoxyphenyl)]propane (BAPP), 2,2-bis[4-(4-aminophenoxyphenyl)] hexafluoropropane (HFBAPP), 1,3-bis(3-aminophenoxy) benzene (APB-133), 2,2-bis(3-aminophenyl)hexafluoropropane, 2,2-bis(4-aminophenyl)hexafluoropropane (Bis-A-AF), 4,4′-bis(4-amino-2-trifluoromethylphenoxy) biphenyl, 4,4′-[1,3-phenylenebis(1-methyl-ethylidene)] bisaniline (Bisaniline-M)
with the proviso that:
i. if X is O, then Y is not m-phenylenediamine (MPD), bis-(4-(4-aminophenoxy)phenyl)sulfone (BAPS) and 3,4′-diaminodiphenyl ether (3,4′-ODA); BAPP, APB-133, Bisaniline-M
ii. if X is S(O)₂, then Y is not 3,3′-diaminodiphenyl sulfone (3,3′-DDS);
iii. if X is C(CF₃)₂, then Y is not m-phenylenediamine (MPD), bis-(4-(4-aminophenoxy)phenyl)sulfone (BAPS), 9,9-bis(4-aminophenyl)fluorene (FDA), and 3,3′-diaminodiphenyl sulfone (3,3′-DDS);
iv. if X is O-Ph-C(CH₃)₂-Ph-O or O-Ph-O—, then Y is not m-phenylene diamine (MPD), FDA, 3,4′-ODA, DAM, BAPP, APB-133, bisaniline-M.

This polyimide resin is dissolved in screen-printing solvents as described above, and then electrically conductive powders dispersed within the solution to from a thick film paste which is then printed on the film, dried, and formed into the electrode.

In an embodiment, the heater or heating device may be used in applications such as: rigid, semi rigid, flexible, semi flexible, single sided, multilayer additive or semi-additive printed heating applications including but not limited to: mobile devices, power electronics, automotive, avionics, aviation, green power, deicing et. Al., high reliability, high speed, high frequency, telecom, medical, wearable, energy storage and wind power, transportation; train, boat, clothing, industrial processes, and cooking applications.

### EXAMPLES

The concepts described herein will be further described in the following examples, which do not limit the scope of the invention described in the claims.

### Example 1

A polyimide resin was prepared in the dry and powdered state by reacting monomers TFMB, 6FAP and 6FDA in a ratio of 33/10/57 through the well-known process of first making polyamic acid in DMAC solvent, controlling the molecular weight of said polyamic acid with end-capping additives, then chemically imidizing and precipitating the polyimide polymer using methanol neat additions to the DMAC solution. The precipitate was washed several times with methanol neat, filtered and then dried at approximately 200 C to form a dry and handleable powder and to eliminate DMAC residuals to below 0.1% basis weight. The resulting powder was dry, fluffy and stored at room temperature.

### Example 2

The polymer of Example 1 was dissolved in a solvent which was favorable for use in screen printing. Such solvents comprise of, but are not limited to: dibasic esters, Dowanol solvents, acetates, carbitols, ethers, glycol ethers, triethyl phosphate, diethyl adipate, and the like. In all cases a ratio of approximately 5 to 50% resin and 95 to 50% solvent was used, with various combinations of chemically different solvents used. The polyimide resin easily dissolved in these solvents, and viscosities of about 5 to 250 Pas at a shear rates of 0.4/sec were measured at room temperature. Such solutions were temperature and time stable, with the polyimide resin dissolved completely in the solvents to from a clear and translucent solution.

### Example 3

The polyimide solution of Example 2 was used as the basis for the manufacture of a polymer thick film paste. The polyimide solution was mixed with Ag particulates of sizes typically of below 20 microns in largest dimension, those particulates being spherical or flaked in nature, or mixtures thereof. Typical ratios of polymeric solution and powders were 60/40 powder/polymer solution, but this varied from 80/20 to 50/50. Flaked Ag is the preferred powder morphology since it gives the highest electrical conductivity, but spherical Ag and mixtures of flake and spherical are possible. Furthermore, use of other electrically conductive metal powders are possible including, but not limited to, Cu, Pt, Pd, Ni, Au and Ag-coated Cu.

### Example 4

Film heater samples made from the polymer thick film paste of Example 3 were prepared by both screen printing and lab paint masking plus oven drying techniques onto Kapton® 200RS100 as shown in FIG. 1. The Kapton® 200RS100 film is an electrically resistive polyimide film with an engineered design resistance of 100 Ohms/sq. The paste was used to form conductive electrodes of 1.5 cm widths×11.0 cm lengths with trace spacing of 26 cm between electrodes. The printed silver paste was dried at 130° C. for 10 min and then at 200° C. for 30 min. The crosshatch adhesion test with the cured polymer thick film conductor samples was carried out according to procedure ASTM D3359. The adhesion from the Ag paste was found to be good. The power supply used for this research was a Staco Energy Variac Model: 3PN1520B-DVM (capable output=0 to 280 VAC with max current output=9.5 amps). The heater was designed to achieve a maximum temperature output of ˜200° C. (392° F.) when powered with 220 VAC. The cured polymer thick film conductor electrodes gave resistivity of 0.0109 Ohms/sq for a single 1× screen print and a resistivity of 0.0047 Ohms/sq for a double 2× screen print. Resistivity was measured by a Veeco FP5000 four point probe meter.

The Kapton® 200RS100 resistive film and conductor paste composition structure proved to be capable of thermal cycling from room temperature to temperatures around 200 C, and stable when heated in air for more than 700 hours at temperature using an applied voltage of approximately 220 VAC. Such composites structures could be used for high temperature heaters in a variety of electrical devices.

### Example 5

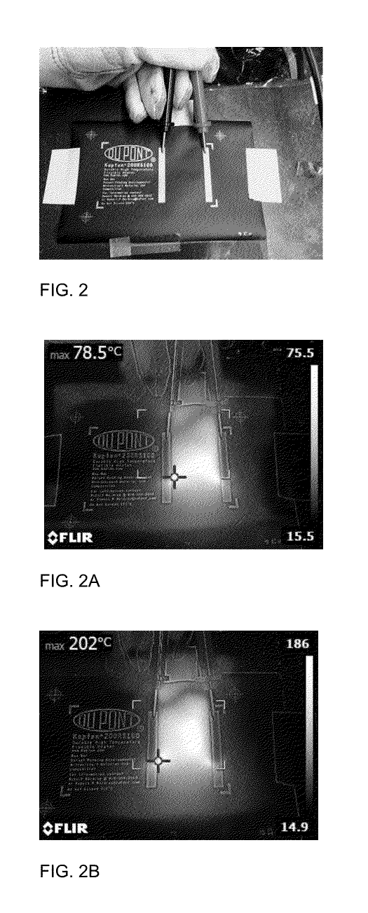

A polymer thick film paste of Example 3 was screen printed as two electrodes (positive and negative bus bars) with dimensions of 0.5 cm width×4.5 cm length with a trace spacing of 3.0 cm between electrodes as shown in FIG. 2. Both electrodes were powered by a Mastech variable DC power supply Model HY5005-2. The heater gave a maximum temperature of 78.5 C (shown in FIG. 2A) and 202 C (FIG. 2B) when powered with 12 VDC or 24 VDC, respectively.

What is claimed is:

1. A process to prepare a high temperature heater comprising:
a. preparing an electrically conductive paste, capable of high in use operating temperature;
b. applying the electrically conductive paste to form an electrode on an electrically resistive polyimide film, and
c. attaching a power source to the electrically conductive electrode,
wherein the electrically conductive high in use operating temperature paste comprises a polyimide resin represented by formula I: 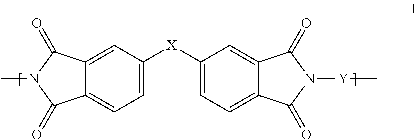
wherein X is C(CH3)2, O, S(O)2 or C(CF3)2, O-Ph-C(CH₃)₂-Ph-O, O-Ph-O— or a mixture of two, or more of C(CH3)2, O, S(O)2, and C(CF3)2, O-Ph-C(CH₃)₂-Ph-O, O-Ph-O—;
wherein Y is diamine component or mixture of diamine components selected from the group consisting of:
m-phenylenediamine (MPD),
3,4′-diaminodiphenyl ether (3,4′-ODA),
4,4′-diamino-2,2′-bis(trifluoromethyl)biphenyl (TFMB),
3,3′-diaminodiphenyl sulfone (3,3′-DDS),
4,4′-(Hexafluoroisopropylidene)bis(2-aminophenol) (6F-AP)
bis-(4-(4-aminophenoxy)phenyl)sulfone (BAPS) and
9,9-bis(4-aminophenyl)fluorene (FDA);
2,3,5,6-tetramethyl-1,4-phenylenediamine (DAM), 2,2-bis[4-(4-aminophenoxyphenyl)]propane (BAPP), 2,2-bis[4-(4-aminophenoxyphenyl)] hexafluoropropane (HFBAPP), 1,3-bis(3-aminophenoxy) benzene (APB-133), 2,2-bis(3-aminophenyl)hexafluoropropane, 2,2-bis(4-aminophenyl)hexafluoropropane (Bis-A-AF), 4,4′-bis(4-amino-2-trifluoromethylphenoxy) biphenyl, 4,4′-[1,3-phenylenebis(1-methyl-ethylidene)] bisaniline (Bisaniline-M)
with the proviso that:
i. if X is O, then Y is not m-phenylenediamine (MPD), bis-(4-(4-aminophenoxy)phenyl)sulfone (BAPS) and 3,4′-diaminodiphenyl ether (3,4′-ODA); BAPP, APB-133, Bisaniline-M
ii. if X is S(O)₂, then Y is not 3,3′-diaminodiphenyl sulfone (3,3′-DDS);
iii. if X is C(CF₃)₂, then Y is not m-phenylenediamine (MPD), bis-(4-(4-aminophenoxy)phenyl)sulfone (BAPS), 9,9-bis(4-aminophenyl)fluorene (FDA), and 3,3′-diaminodiphenyl sulfone (3,3′-DDS);
iv. if X is O-Ph-C(CH₃)₂-Ph-O or O-Ph-O—, then Y is not m-phenylene diamine (MPD), FDA, 3,4′-ODA, DAM, BAPP, APB-133, bisaniline-M dissolved in a solvent suited to screen printing, with an electrically conductive metal powder dispersed to from a screen printable tick film paste.

2. A high operating temperature heater made using the process of claim 1.

3. The high operating temperature heater of claim 2, wherein the temperature of the high operating temperature heater operates in the range of room temperature to 210° C.

4. The high operating temperature heater of claim 2, wherein the electrically conductive electrode further comprises inorganic fillers selected from the group consisting of Au, Ag, Cu, Pd, Pt, Ni, Al, Ag coated Cu and mixture thereof.

5. The electrically conductive electrode of claim 2, wherein the electrically conductive electrode paste further comprises an inorganic filler of Ag in the amount of 40 to 80 wt % of the paste having a dried and cured thickness of 4 to 100 microns and an electrical resistivity 4 to 70 mohms/sq/mil.

6. The high temperature heater capable of high in use operating temperature of claim 5, wherein the resistance of the heater utilizing a film like Kapton® 200RS100 defined and constructed through the positioning, size, and spacing of the electrodes on the electrically resistive film to form an electrical resistance which is desired for the particular application.

7. A heater or heating device for:
a. a base portion having chamber section;
b. a high temperature heater contacting the chamber section;
c. a power source for the high temperature heater; and
d. a lid for the chamber section,
wherein the electrically resistive high temperature heater paste comprises a polyimide represented by formula I: 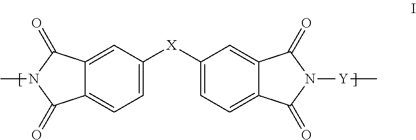
wherein X is C(CH3)2, O, S(O)2 or C(CF3)2, O-Ph-C(CH₃)₂-Ph-O, O-Ph-O— or a mixture of two, or more of C(CH3)2, O, S(O)2, and C(CF3)2, O-Ph-C(CH₃)₂-Ph-O, O-Ph-O—;
wherein Y is diamine component or mixture of diamine components selected from the group consisting of:
m-phenylenediamine (MPD),
3,4′-diaminodiphenyl ether (3,4′-ODA),
4,4′-diamino-2,2′-bis(trifluoromethyl)biphenyl (TFMB),
3,3′-diaminodiphenyl sulfone (3,3′-DDS),
4,4′-(Hexafluoroisopropylidene)bis(2-aminophenol) (6F-AP)
bis-(4-(4-aminophenoxy)phenyl)sulfone (BAPS) and
9,9-bis(4-aminophenyl)fluorene (FDA);
2,3,5,6-tetramethyl-1,4-phenylenediamine (DAM), 2,2-bis[4-(4-aminophenoxyphenyl)]propane (BAPP), 2,2-bis[4-(4-aminophenoxyphenyl)] hexafluoropropane (HFBAPP), 1,3-bis(3-aminophenoxy) benzene (APB-133), 2,2-bis(3-aminophenyl)hexafluoropropane, 2,2-bis(4-aminophenyl)hexafluoropropane (Bis-A-AF), 4,4′-bis(4-amino-2-trifluoromethylphenoxy) biphenyl, 4,4′-[1,3-phenylenebis(1-methyl-ethylidene)] bisaniline (Bisaniline-M)
with the proviso that:
i. if X is O, then Y is not m-phenylenediamine (MPD), bis-(4-(4-aminophenoxy)phenyl)sulfone (BAPS) and 3,4′-diaminodiphenyl ether (3,4′-ODA); BAPP, APB-133, Bisaniline-M
ii. if X is S(O)₂, then Y is not 3,3′-diaminodiphenyl sulfone (3,3′-DDS);
iii. if X is C(CF₃)₂, then Y is not m-phenylenediamine (MPD), bis-(4-(4-aminophenoxy)phenyl)sulfone (BAPS), 9,9-bis(4-aminophenyl)fluorene (FDA), and 3,3′-diaminodiphenyl sulfone (3,3′-DDS);
iv. if X is O-Ph-C(CH₃)₂-Ph-O or O-Ph-O—, then Y is not m-phenylene diamine (MPD), FDA, 3,4′-ODA, DAM, BAPP, APB-133, bisaniline-M.
